(19) United States
(12) Patent Application Publication
(10) Pub. No.: US 2025/0060988 A1
(43) Pub. Date: Feb. 20, 2025

(54) TECHNIQUES FOR TASK AUTOMATION UTILIZING VERSION CONTROL

(71) Applicant: Red Hat, Inc., Raleigh, NC (US)

(72) Inventors: Pierre-Yves CHIBON, Puteaux (FR); Adam MILLER, Austin, TX (US)

(21) Appl. No.: 18/449,459

(22) Filed: Aug. 14, 2023

(51) Int. Cl. G06F 9/48; G06F 9/445

(52) U.S. Cl. CPC G06F 9/4843; G06F 9/44536

(57) ABSTRACT

A method of automation includes obtaining a configuration of a task group, the task group comprising a plurality of tasks, each of the plurality of tasks to execute on a computing node of a plurality of computing nodes. For each task of the plurality of tasks of the task group, a version control system is accessed to retrieve the task. Each task is stored as a data object within the version control system. The respective tasks of the plurality of tasks are transmitted to one or more of the plurality of computing nodes for execution.

### TECHNICAL FIELD

Aspects of the present disclosure relate to task automation and, more particularly, to task automation utilizing version control.

### BACKGROUND

Modern computer infrastructures are very complex. The computer infrastructures may include computing nodes operating as physical computing devices, virtual computing devices, containers, and the like. In some cases, interacting with the computer infrastructure, such as to perform configuration and/or execution of a payload, may include operations on multiple different computing nodes of the computer infrastructure. Task automation tools have been developed that reduce a complexity of this operation by allowing for the configuration and deployment of tasks to the various computing nodes to be automated.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the scope of the described embodiments.

FIG. 1 is a schematic block diagram that illustrates an example system, according to some embodiments of the present disclosure.

FIG. 2A illustrates an example task group including a plurality of tasks, in accordance with some embodiments of the present disclosure.

FIG. 2B illustrates an example task group including a modification to a task, in accordance with some embodiments of the present disclosure.

FIG. 3 is a flow diagram of a method of modifying and/or generating a new task group, according to some embodiments of the present disclosure.

FIG. 4 is a flow diagram of a method for performing task automation, in accordance with some embodiments of the present disclosure.

FIG. 5 is a component diagram of an example of a device architecture, in accordance with embodiments of the disclosure.

FIG. 6 is a block diagram that illustrates an example system, according to some embodiments of the present disclosure.

### DETAILED DESCRIPTION

As system configuration becomes more and more complex, systems that are capable of automating tasks become more useful. As an example, a web server configuration may involve a number of different systems, such as a computing device to execute the web server application, a computing device to store/operate a database used by the web server, a load balancing system, a logging system, and the like. Setting up all of these systems may take a large amount of effort. Task automation systems may simply this process by providing an automated method to perform setup. Moreover, the use of task automation systems may allow for a particular setup, once established, to be easily repeatable in a uniform manner. One example of a task automation system is Red Hat™ Ansible™. Ansible is software that can run on a task automation computing device and use playbooks to perform operations on managed node computing devices (e.g., servers). Playbooks are configuration files in YAML format that can declare desired tasks to be performed by the managed node computing devices. Ansible can ingest the playbooks and responsively perform operations to configure the managed node computing devices as specified in the playbooks. Other examples of task automation systems include, but are not limited to, Puppet™, Chef™, and SaltStack™.

Playbooks (and their associated tasks) may be modified over time. As the tasks of the playbook change, it can be difficult to track how the tasks have been modified. Moreover, the lists of tasks may be needlessly duplicated. For example, the tasks to set up a database system may be complex, but they may be similar whether the underlying database is in use by a point-of-sale system or a webserver. To avoid duplicating work, it may be useful to share the underlying tasks used for the setup between playbooks. However, sharing brings its own challenges. If a task is shared, an alteration to the task may inadvertently impact another user that was sharing the task. As a result of the complex interactions of the tasks, and the potential for lack of visibility to changes within these tasks, the configuration of tasks in a task automation may be difficult to maintain and prone to error.

The present disclosure addresses the above-noted and other deficiencies by integrating the grouping of tasks for a task automation system with a version control system. By placing individual tasks of the task grouping (e.g., a playbook in Ansible) under version control, it may be much easier to track changes to the task over time and across task groupings. Moreover, when an individual task is shared between task groupings, a change to a shared task may not necessarily impact the other task grouping. Version control systems allow for data objects within branches of the version control system to be maintained at a given version (even if changed by other users of the version control system) until expressly advanced to a different version. By implementing the tasks of a task group as data objects of a branch of the version control system, task automation operations can take advantage of this versioning to maintain stability of the task group operations while still providing visibility and allowing a task group to easily advance to newer versions.

In addition, the use of the version control system to instantiate tasks may allow for those tasks to easily be shared between other task groups. Many version control systems are implemented in a graph style such that individual data objects of the version control system (in an example embodiment, tasks) can be incorporated as nodes (e.g., interconnected data objects) in other branches. The use of the version control system for the task groupings would allow for a large number of task groupings to coexist simultaneously. In addition, the native logging of the version control system may provide records of all of the creation and/or execution operations of the task grouping, since execution of the task grouping may involve access/retrieval of the data objects (e.g., tasks) from the version control system. This may allow for enhanced auditing, which may provide further security and accountability with respect to the task automation.

Using Ansible as a task automation system and git as a version control system for a non-limiting example, Ansible may be modified so that tasks in playbooks become the equivalent of commits in branches in a git repository. Each playbook may be a separate branch, each task in the playbook may be a separate commit (e.g., within git). To change a task in a playbook, a branch to an existing branch may be generated in git just before the task to be updated. The new branch may then either be merged back into the original branch for the other tasks or continue diverging from the branch point. In such an example embodiment, executing Ansible may then no longer point to a file on a filesystem, but instead to a branch in a git repository. The git repository may be configured to be in a central location, thus enforcing that user editing the Ansible repository also push their changes to the central location.

Embodiments of the present disclosure may provide a technological solution that increases the reliability and efficiency of computer technology associated with task automation of computing devices. By placing task configurations under version control, inadvertent changes that impact the operation of the task automation may be reduced and/or avoided. In addition, the use of the version control system may allow the tasks associated with a task group for task automation to be set up more quickly from existing tasks, which may speed up the provisioning of such a task group. Also, the use of a version control system may increase an amount of auditing and logging of the operations of the various tasks groups, allowing for monitoring both of executions of the tasks groups as well as modifications to the tasks of the task groups. Embodiments of the present disclosure may improve the operation of a computer by reducing errors associated with task automation and reducing downtime associated with task setup and administration.

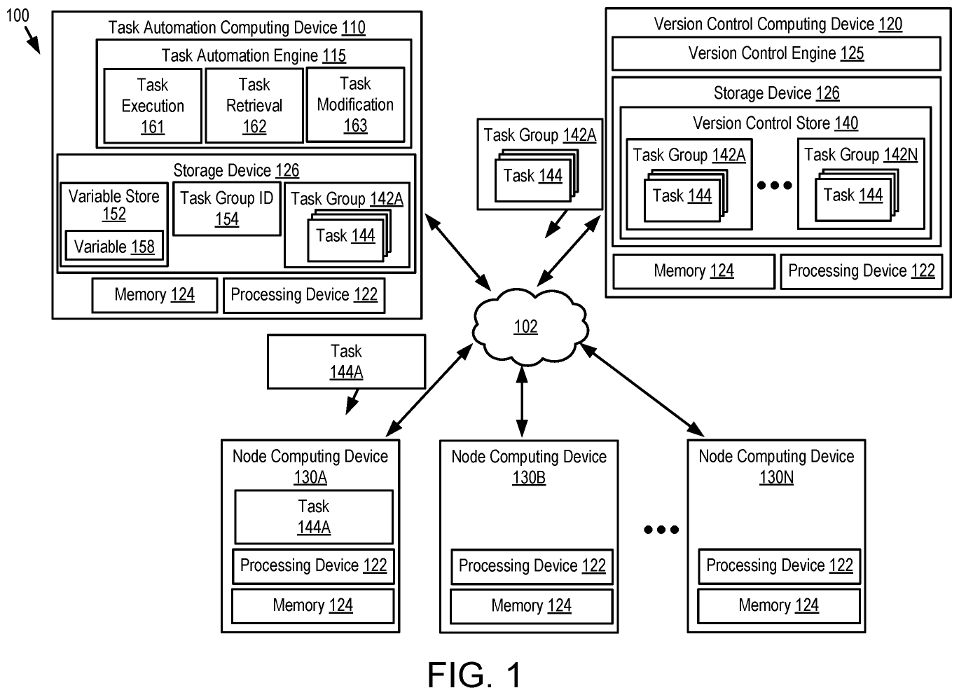

FIG. 1 is a schematic block diagram that illustrates an example system 100, according to some embodiments of the present disclosure. FIG. 1 and the other figures may use like reference numerals to identify like elements. A letter after a reference numeral, such as “130A,” indicates that the text refers specifically to the element having that particular reference numeral. A reference numeral in the text without a following letter, such as “130,” refers to all of the elements in the figures bearing that reference numeral.

As illustrated in FIG. 1, the system 100 includes a task automation computing device 110, a version control computing device 120 (also referred to herein as a version control system 120), and a plurality of node computing devices 130 (also collectively referred to herein as computing devices 110, 120, 130). In FIG. 1, the node computing devices 130 are illustrated as including a first node computing device 130A, a second node computing device 130B, up to an Nth node computing device 130N. The number and configuration of the node computing devices 130 is merely an example, and is not intended to limit the embodiments of the present disclosure.

The computing devices 110, 120, and 130 may be coupled to each other (e.g., may be operatively coupled, communicatively coupled, may communicate data/messages with each other) via network 102. Network 102 may be a public network (e.g., the internet), a private network (e.g., a local area network (LAN) or wide area network (WAN)), or a combination thereof. In one embodiment, network 102 may include a wired or a wireless infrastructure, which may be provided by one or more wireless communications systems, such as a WiFi™ hotspot connected with the network 102 and/or a wireless carrier system that can be implemented using various data processing equipment, communication towers (e.g., cell towers), etc. In some embodiments, the network 102 may be an L3 network. The network 102 may carry communications (e.g., data, message, packets, frames, etc.) between the task automation computing device 110, the version control computing device 120, and/or the plurality of node computing devices 130.

Each computing device 110, 120, and 130 may include hardware such as processing device 122 (e.g., processors, central processing units (CPUs), memory 124 (e.g., random access memory (e.g., RAM), storage devices 126 (e.g., hard-disk drive (HDD), solid-state drive (SSD), etc.), and other hardware devices (e.g., sound card, video card, etc.).

Processing device 122 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. Processing device 122 may also include one or more special-purpose processing devices such as an application specific integrated circuit (ASIC), a field programmable gate array (FPGA), a digital signal processor (DSP), network processor, or the like.

Memory 124 may include volatile memory devices (e.g., random access memory (RAM)), non-volatile memory devices (e.g., flash memory) and/or other types of memory devices. In certain implementations, memory 124 may be non-uniform access (NUMA), such that memory access time depends on the memory location relative to processing device 122. In some embodiments, memory 124 may be a persistent storage that is capable of storing data. A persistent storage may be a local storage unit or a remote storage unit. Persistent storage may be a magnetic storage unit, optical storage unit, solid state storage unit, electronic storage units (main memory), or similar storage unit. Persistent storage may also be a monolithic/single device or a distributed set of devices. Memory 124 may be configured for long-term storage of data and may retain data between power on/off cycles of the computing devices 110, 130, and 150.

The storage device 126 may comprise a persistent storage that is capable of storing data. A persistent storage may be a local storage unit or a remote storage unit. Persistent storage may be a magnetic storage unit, optical storage unit, solid state storage unit, electronic storage units (main memory), or similar storage unit. Persistent storage may also be a monolithic/single device or a distributed set of devices.

The configurations of the processing devices 122, the memory devices 124, and/or the storage devices 126 within the computing devices 110, 120, 130 of FIG. 1 are merely examples, and are not intended to limit the embodiments of the present disclosure. Although, for simplicity, a single processing device 122 is depicted in the computing devices 110, 120, 130 depicted in FIG. 1, other embodiments of the computing devices 110, 120, 130 may include multiple processing devices 122, memory devices 124, storage devices 126, or other devices.

Each computing device 110, 120, 130 may comprise any suitable type of computing device or machine that has a programmable processor including, for example, server computers, desktop computers, laptop computers, tablet computers, smartphones, set-top boxes, systems on a chip (SOC), embedded computing devices, etc. In some examples, each of the computing devices 110, 120, 130 may comprise a single machine or may include multiple interconnected machines (e.g., multiple servers configured in a cluster). The computing devices 110, 120, 130 may be implemented by a common entity/organization or may be implemented by different entities/organizations. For example, the task automation computing device 110 may be operated by a first company/corporation, the version control computing device 120 may be operated by a second company/corporation, and/or the node computing devices 130 may be operated by a third company/corporation.

Though illustrated as separate computing devices in FIG. 1, this is merely for ease of discussion, and is not intended to limit the embodiments of the present disclosure. In some embodiments, one or more of the computing devices 110, 120, 130 may be combined. For example, in some embodiments, the task automation computing device 110 and the version control computing device 120 may be a same computing device.

The task automation computing device 110 may be configured to execute a task automation engine 115. The task automation engine 115 may be configured to execute a task group 142 on one or more node computing devices 130. A task group 142 may be a logical configuration of a plurality of tasks 144. Each of the tasks 144 may be configured to be one or more operations that are to be executed on one of the node computing devices 130. The tasks 144 may include an ordering, such that the tasks 144 are sequentially executed on the node computing devices 130.

In some embodiments, the task automation engine 115 may be or include an Ansible system. In Ansible, tasks 144 may be organized into plays. The plays may be further organized into playbooks, which may be similar to the task groups 142 described herein. An example of an Ansible playbook is included below:

```
---
- name: Apache server installed
  hosts: web
  become: true
  tasks:
  - name: latest Apache version installed
  yum:
    name: httpd
    state: latest
  - name: Apache enabled and running
  service:
    name: httpd
    enabled: true
    state: started
- name: copy index.html
copy:
    src: web.html
    dest: /var/www/html/index.html
```

The above Ansible example illustrates a task group 142 containing a plurality of tasks 144. More specifically, the example illustrates a task group 142 having the name “Apache server installed” with three tasks 144 respectively named “latest Apache version installed,” “Apache enabled and running,” and “copy index.html.” When the example task group 142 is submitted for executing, the tasks 144 may be executed (e.g., sequentially) on the “hosts” (“web” in this example) designated by the task group 142.

The task automation engine 115 may include a task retrieval operation 162 that is configured to retrieve a task group 142 and its associated tasks 144 from a version control computing device 120 that will be described further herein. Once retrieved, a task execution operation 161 of the task automation engine 115 may be configured to execute the individual tasks 144 of the task group 142 on one or more of the node computing devices 130. For example, the task execution operation 161 may transmit (e.g., over network 102) a first task 144A associated with a task group 142 to a first node computing device 130A of the plurality of node computing devices 130. The task execution operation 161 may repeat the executions of the tasks 144 of the task group 142 (e.g., transmitting the tasks 144 to one or more of the node computing devices 130) for each of the tasks 144 of the task group 142. More details regarding the structure and retrieval of the task group 142 and/or the tasks 144 will be provided herein.

The version control computing device 120 (also referred to herein as a version control system 120) may be configured to execute a version control engine 125. The version control engine 125 may be configured to execute version control operations with respect to a version control store 140. The version control engine 125 may manage changes to data objects within the version control store 140. The version control engine 135 may manage changes to the data objects of the version control store 140 over time. When data objects of the version control store 140 under are modified, the version control engine 125 may increment a version of the data object, and maintain both the prior data object as well as the changed data object. Examples of version control systems that may be implemented by the version control engine 125 include git, Mercurial, and SVN, just to name a few.

For example, in some embodiments, the version control engine 125 may be configured to manage one or more tasks 144 as data objects within the version control store 140. In some embodiments, the one or more tasks 144 may be organized into task groups 142. In FIG. 1, the version control store 140 is illustrated as having a first task group 142A (including a first plurality of tasks 144), up to an Nth task group 142N (also including a plurality of tasks 144). The configuration of the task groups 142 in FIG. 1 is merely an example, and is not intended to limit the embodiments of the present disclosure. In an example embodiment in which the version control engine 125 is based on git, the tasks 144 may represent the commits of the version control system.

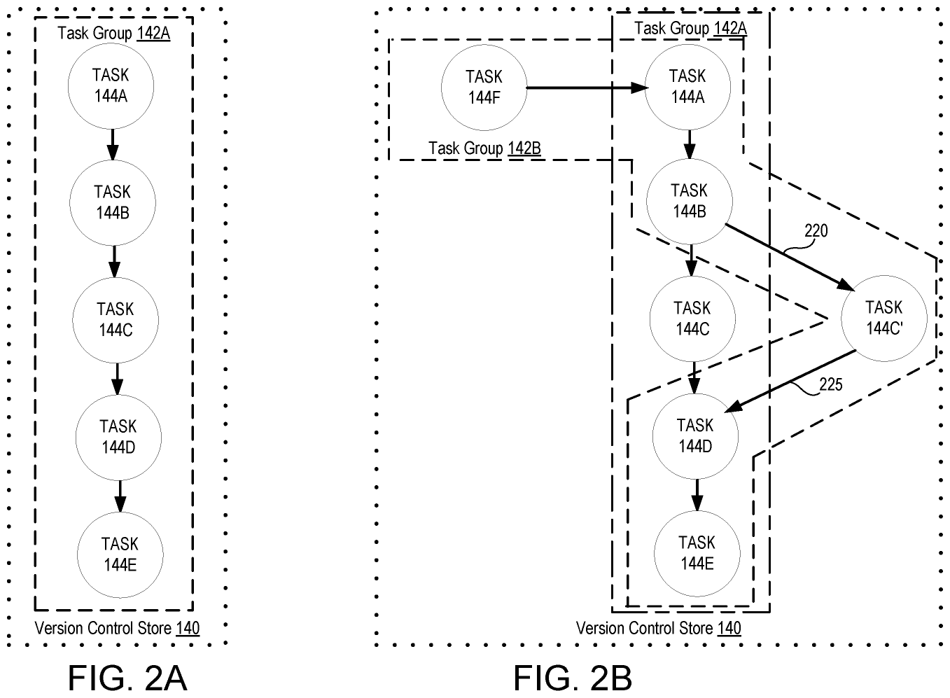

Within the version control store 140, revisions to the data objects may be represented as branches off of a main line of development, which may be visualized as one or more parallel lines of development (the “mainlines” of the branches) branching off a trunk. Revisions to the data objects (e.g. tasks 144) may occur in sequence over time, and thus can be arranged in order, either by revision number or timestamp. In some embodiments, more current revisions to the data objects (e.g., tasks 144) may be based on past revisions. In the simplest case, with no branching or undoing, each revision may be based on its immediate predecessor alone, and they form a simple line, with a single latest version. In graph theory terms, drawing each revision as a point and each “derived revision” relationship as an arrow (conventionally pointing from older to newer, in the same direction as time), this is a linear graph, an example of which is illustrated in FIG. 2A.

FIG. 2A illustrates an example task group 142A including a plurality of tasks 144, in accordance with some embodiments of the present disclosure. An explanation of elements of FIG. 2A that have been previously described will be omitted for brevity. As illustrated in FIG. 2A, the task group 142A may be formed within the version control store 140 as a branch. Each task 144 that is associated with the task group 142A may be organized within the version control store 140 as a snapshot and/or commit. The tasks 144 may be organized sequentially in the order that they are to be executed. For example, FIG. 2A illustrates an example in which a task group 142A contains five tasks 144, including a first task 144A, a second task 144B, a third task 144C, a fourth task 144D, and a fifth task 144E. The configuration of tasks 144 in the task group 142A is merely an example and is not intended to limit the embodiments of the present disclosure.

In the first task group 142A, the first task 144A is intended to execute first, the second task 144B is intended to execute second in order, the third task 144C is intended to execute second in order, and so on. In some embodiments, the ordering of the tasks 144 may be represented in the version control store 140 as revisions of the prior task 144. Thus, if a second task 144B is to follow a first task 144A in sequential order of execution, it is represented as a revision to the first task 144A within the version control store 140. For example, if the version control engine 125 is configured to implement a git version control system, the tasks 144 may be represented as commits within a branch of the git system, where the branches are associated with task groups 142.

The data objects representing the tasks 144 within the version control store 140 may contain the instructions and/or metadata needed to execute the particular task 144. For example, if the task automation engine 115 is configured to execute an Ansible system, the individual tasks 144 within the version control store 140 may include the YAML configuration instructions for a play of a playbook, and the playbook may be represented by the task group 142.

Referring back to FIG. 1, the task automation engine 115 may utilize the capabilities of the version control engine 125 to perform its task automation functions. For example, prior to performing the task execution operation 161, the task retrieval operation 162 may communicate with the version control engine 125 (e.g., over network 102) to retrieve a task group 142 (e.g., a first task group 142A) to be executed. In some embodiments, the task retrieval operation 162 may be performed in response to a request to execute a particular task group 142 (e.g., in an Ansible system, the execution of a playbook may be requested). In some embodiments, the task group 142 to be executed may be identified by a task group identifier (ID) 154. In some embodiments, the task group ID 154 may be a numeric number or a name associated with the task group 142 (e.g., a first task group 142A) to be executed. In some embodiments, the task retrieval operation 162 may provide the task group ID 154 to the version control engine 125 to retrieve the task group 142 (e.g., the first task group 142A) from the version control store 140.

In some embodiments, in response to the request from the task retrieval operation 162, the task group 142 may be retrieved from the version control store 140. For example each of the tasks 144 of the task group 142 may be sequentially retrieved from the version control store 140. In embodiments in which the version control store 140 is implemented based on git, the commits (e.g., tasks 144) of a branch (e.g., a task group 142) may be extracted. In some embodiments, in response to the retrieval of the task group 142, and its associated tasks 144, an automatic record may be logged by the version control engine 125. In this way, the execution of the task group 142, and by whom (e.g., the task automation engine 115) may be automatically logged.

The task execution operation 161 may parse the retrieved task group 142A to extract its associated tasks 144. In some embodiments, the tasks 144 may be stored in the version control store 140 with execution variables 158. The execution variables 158 may be placeholders within the respective task 144 that may be replaced with actual values by the task execution operation 161 prior to executing the task 144. For example, an execution variable 158 may identify a placeholder for a node computing device 130 upon which the task 144 is to execute. In some embodiments, the task execution operation 161 may replace the execution variable 158 with a value from a variable store 152 stored (e.g., in storage device 126) on the task automation computing device 110.

After the tasks 144 of the task group 142A have been parsed and, in some embodiments, any execution variables 158 of the tasks 144 replaced with variables from the variable store 152, each of the tasks 144 may be transmitted to a respective node computing device 130 of the plurality of node computing devices 130. For example, a first task 144A of the task group 142A may be transmitted over the network 102 to a first node computing device 130A, which may execute the first task 144A. In some embodiments, the tasks 144 of the task group 142A may be transmitted by the task execution operation 161 in order. For example, the order of the tasks 144 of the task group 142A may be specified by the order of the data objects (e.g., commits in a git-based system) within the version control store 140.

The example of FIG. 2A illustrates a structure of task group 142 in which no modifications to the tasks 142 has yet been processed. However, by utilizing the version control store 140 for the storage of the tasks 144 and/or task groups 142, the structure of the version control store 140 may be leveraged to provide additional advantages for task automation.

In some embodiments, a task group 142 may be configured as a branch within the version control store 140, with tasks 144 as data objects of the branch. Within the version control store 140, if a task 144 is modified, an additional branch is created. As a result, multiple tasks 144 (e.g., an original task 144 and a modified version of the original task 144) may be based on a prior task 144. In some embodiments, to modify an existing task 144 of a task group 142, a new branch may be created within the version control store 140, and the new branch may be merged back to the original branch after the task 144 that was modified.

In the presence of merges, the resulting graph of the tasks 144 within the task groups 142 of the version control store 140 is no longer a tree (as a given task 144 can have multiple parents) but is instead a rooted directed acyclic graph (DAG). The graph is acyclic since the parents of a particular task 144 are backwards in time, and rooted because there is an oldest version.

FIG. 2B illustrates an example task group 142B including a modification to a task 144C, in accordance with some embodiments of the present disclosure. An explanation of elements of FIG. 2B that have been previously described will be omitted for brevity.

FIG. 2B illustrates a scenario in which the third task 144C of the first task group 142A is modified to generate a modified third task 144C′. As an example, the instructions of the third task 144C may be modified to alter the task performed by the third task 144C. For example, the configuration code, such as the YAML-based instructions in an Ansible-based system, of the third task 144 may be modified to generate the modified third task 144C′. The generation of the modified third task 144C′ may create a second task group 142B that includes the modified third task 144C′. For example, if the version control engine 125 is based on a git system, the modified third task 144C′ may be a commit and the second task group 142B may be a branch within the git-based version control store 140.

The creation of the modified third task 144C′ may create a branch 220 from the first task group 142A. The branch 220 may divert from the first task group 142A and join the modified third task 144C′ to the second task 144B, such that the modified third task 144C′ is configured to execute after the second task 144B when the second task group 142B is executed. After the modified third task 144C′, the second task group 142 may further merge 225 back to the fourth task 144D after the third task 144C.

As illustrated in FIG. 2B, the second task group 142B may modify the third task 144C (by generating the modified third task 144C′) without modifying the operation of the first task group 142A. If it is determined that the first task group 142A could also benefit from the changes in the modified third task 144C′, the first task group 142A may be further modified (e.g., by an administrator) to merge to the modified third task 144C′ in a similar manner as the second task group 142B. Moreover, by comparing the third task 144C with the modified third task 144C′, the changes may be transparently determined.

FIG. 2B also illustrates that, in addition to modifying existing tasks 144 of a first task group 142A, the second task group 142B may also add new tasks 144 to its branch. In FIG. 2B, this is illustrated by the addition of a sixth task 144F to the second task group 142B. As illustrated in FIG. 2B, new tasks 144 do not necessarily need to be added at the end of an existing task group 142, but may instead be added in any location. In the example of FIG. 2B, the sixth task 144F is added at the beginning of the second task group 142B, but this is merely an example, and the sixth task 144F could be added at different positions within the second task group 142B without deviating from the embodiments of the present disclosure.

Though FIG. 2B illustrates an example in which a task group 142 is formed by the modification of an existing branch of a task group 142, the embodiments of the present disclosure are not limited to such a configuration. In some embodiments, a task group 142 may be formed by selectively associating tasks 144 within the version control store 140 with a particular task group 142. For example, a new task group 142 may be formed by linking a first task 144 of a first task group 142 with a second task 144 of a second task group, and so on, to form a task group 142 (e.g., a branch) within the version control store 140 that is made up of tasks 144 from a plurality of task groups 142. As an example, if the version control store 140 is based on git, a branch (e.g., a task group 142) may be formed by using the cherry picking functionality of git to link a plurality of commits (e.g., tasks 144).

The modifications to the various task groups 142 described in FIG. 2B may, in some embodiments, be automatically logged by the version control engine 125. Thus, by reviewing the structure of the version control store 140 and/or any associated logging, a history of the various task groups 142 may be determined, such that the source, and timing, of modifications to the task groups 142 may be tracked.

Referring back to FIG. 1, a task modification operation 163 of the task automation engine 115 may be provided to modify a given task group 142 and/or add a new task 144. The task modification operation 163 may be configured to access the version control store 140 and/or interact with the version control engine 125 to modify a given task group 142. Though illustrated as part of the task automation engine 115, it will be understood that the task modification operation 163 may be performed by a separate computing device in some embodiments. In a git-based system, the task modification operation 163 may be configured to generate new commits (e.g., new tasks 144 or modifications to existing tasks 144) and/or branches (e.g., task groups 142) within the version control store 140.

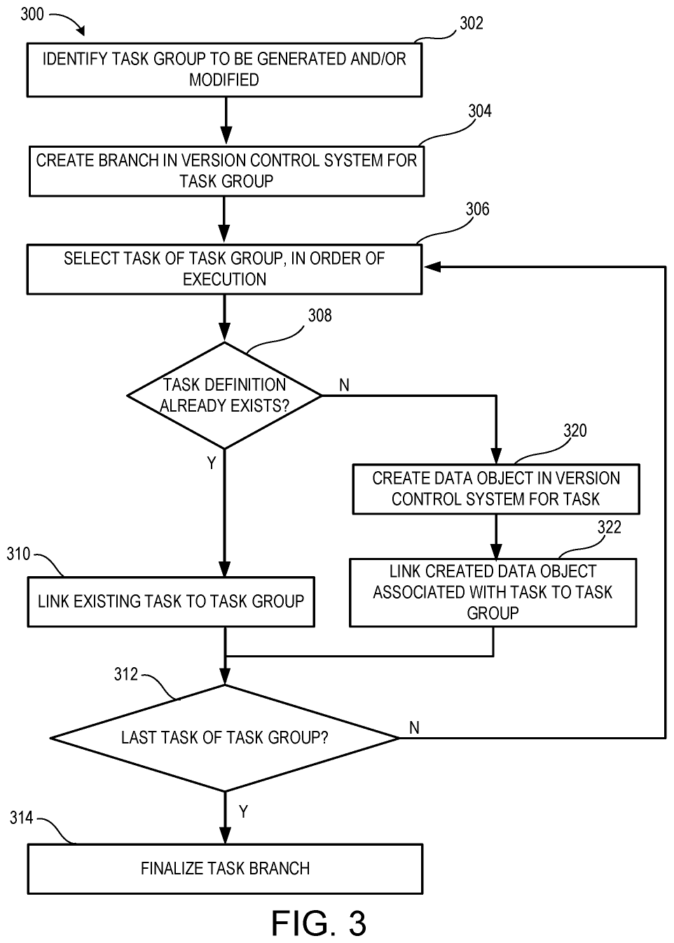

FIG. 3 is a flow diagram of a method 300 of modifying and/or generating a new task group 142, according to some embodiments of the present disclosure. A description of elements of FIG. 3 that have been previously described will be omitted for brevity. Method 300 may be performed by processing logic that may comprise hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. In some embodiments, the method 300 may be performed by a computing device (e.g., task automation computing device 110 and/or version control computing device 120).

With reference to FIG. 3, method 300 illustrates example functions used by various embodiments. Although specific function blocks (“blocks”) are disclosed in method 300, such blocks are examples. That is, embodiments are well suited to performing various other blocks or variations of the blocks recited in method 300. It is appreciated that the blocks in method 300 may be performed in an order different than presented, and that not all of the blocks in method 300 may be performed.

Referring simultaneously to FIGS. 1, 2A, and 2B as well, the method 300 begins at block 302, in which a task group 142 to be modified and/or generated is identified. In some embodiments, a task group ID 154 may be retrieved as described herein with respect to FIG. 1.

At block 304, a branch may be created in the version control store 140 for the identified task group 142. In some embodiments, the branch may be represented as a new task group 142 within the version control store 140, or as a branch form an existing task group 142.

At block 306, a task 144 of the task group 142 may be selected. In some embodiments, the tasks 144 of the task group 142 may be selected in order of execution of the tasks 144. For example, if a task group 142 has five tasks 144 (as in the example of FIG. 2A), a first task 144A of the tasks 144 may be selected.

At block 308 in may be determined whether the task 144 already exists within the version control store 140. If the selected task 144 to be executed as part of the task group 142 being generated/modified already exists (e.g., as part of an existing task group 142) as represented by block 308: Y, then the existing task 144 may be linked to the task group 142 being generated/modified.

If the selected task 144 to be executed as part of the task group 142 being generated/modified does not already exist, as represented by block 308: N, then, at block 320, a data object may be created in the version control store 140 to be associated with the task 144. For example, in a git-based system, a commit may be generated that represents the task 144. In some embodiments, the data object (e.g., a commit) may include the configuration instructions and/or metadata to be used (e.g., by the task execution operation 161) to execute the task 144.

After being created, at block 322, the created data object (e.g., the commit) that is associated with the task 144 may be linked to the task group 142. In embodiments in which the created data object is associated with a modification to an existing task 144, the data object may be linked as a branch from an existing branch (e.g., an existing task group) within the version control store 140, as illustrated in the example of FIG. 2B.

Once the task 144 has either been created or selected from an existing task 144, the operations may continue to block 312 in which it is determined whether there are more tasks 144 within the task group 142 to be processed (e.g., whether present task 144 is the last of the task group 142). If so (block 312: N), the operation may revert to block 306 to select another task 144 of the task group 142 and process it accordingly. If there are no more tasks 144 within the task group 142 to be processed (block 312: Y), the operations may continue to block 314 in which the task group 142 is finalized. Finalizing the task group 142 may include storing each of the data objects associated with the tasks 144 within the version control store 140.

The method 300 illustrated in FIG. 3 may allow for the tasks 144 of a task group 142 to be stored within a version control store 140 such that any modification to the task group 142 may be tracked over time. The method 300 may leverage the functionality of the version control engine 125 to transparently maintain the tasks 144 to be performed as part of a task group 142, while still allowing the order of the tasks 144 to be maintained and tasks 144 to be shared among task groups 142.

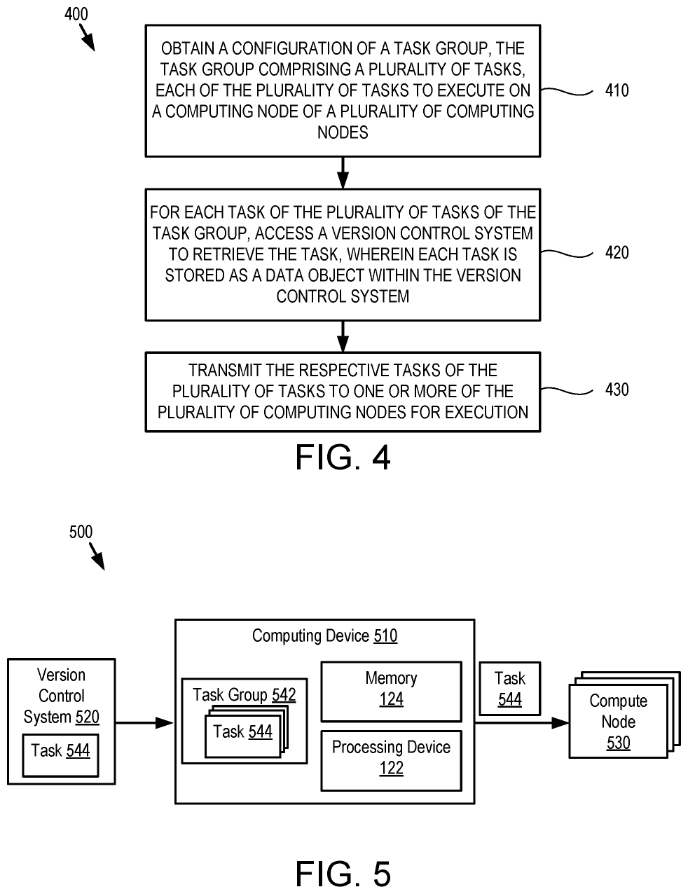

FIG. 4 is a flow diagram of a method 400 for performing task automation, in accordance with some embodiments of the present disclosure. Method 400 may be performed by processing logic that may comprise hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. In some embodiments, the method 400 may be performed by a computing device (e e.g., task automation computing device 110 and/or version control computing device 120).

With reference to FIG. 4, method 400 illustrates example functions used by various embodiments. Although specific function blocks (“blocks”) are disclosed in method 400, such blocks are examples. That is, embodiments are well suited to performing various other blocks or variations of the blocks recited in method 400. It is appreciated that the blocks in method 400 may be performed in an order different than presented, and that not all of the blocks in method 400 may be performed.

Referring simultaneously to FIGS. 1 to 3 as well, the method 400 begins at block 410, in which a configuration of a task group is obtained, the task group comprising a plurality of tasks, each of the plurality of tasks to execute on a computing node of a plurality of computing nodes. In some embodiments, the task group may be similar to the task group 142 described herein with respect to FIGS. 1 to 3. In some embodiments, the plurality of tasks may be similar to the tasks 144 described herein with respect to FIGS. 1 to 3. In some embodiments, the plurality of computing nodes may be similar to the node computing devices 130 described herein with respect to FIGS. 1 to 3.

At block 420, for each task of the plurality of tasks of the task group, a version control system is accessed to retrieve the task. Each task is stored as a data object within the version control system. In some embodiments, the version control system may be similar to the version control engine 125 and/or version control store 140 described herein with respect to FIGS. 1 to 3. In some embodiments, the task group is stored as a branch of a plurality of data objects of the version control system. In some embodiments, a first task of the plurality of tasks of the task group is included in at least one other task group. In some embodiments, for each task of the plurality of tasks of the task group, accessing the version control system to retrieve the task comprises sequentially retrieving each of the plurality of tasks from the version control system.

At block 430, the respective tasks of the plurality of tasks are transmitted to one or more of the plurality of computing nodes for execution. In some embodiments, at least one task of the plurality of tasks of the task group comprises an execution variable, and transmitting the respective tasks of the plurality of tasks to the one or more of the plurality of computing nodes for execution comprises replacing the execution variable with a data value associated with the task group during the execution of the at least one task. In some embodiments, the execution variable may be similar to the execution variable 158 described herein with respect to FIGS. 1 to 3.

In some embodiments, the task group is a first task group, and the method 300 further comprises: modifying a first task of the first task group to create a second task group by creating a branch from the first task group that includes a new data object comprising a second task. In some embodiments, the method 300 further includes merging the branch from the second task of the second task group to connect to a third task of the first task group.

FIG. 5 is a component diagram of an example of a device architecture 500, in accordance with embodiments of the disclosure. The device architecture 500 includes computing device 510 having processing device 122 and memory 124, as described herein with respect to FIGS. 1 to 4.

The computing device 510 may obtain a configuration of a task group 542. The task group 542 may include a plurality of tasks 544. Each of the plurality of tasks 544 may be configured to execute on a computing node 530 of a plurality of computing nodes 530. In some embodiments, the task group 542 may be similar to the task group 142 described herein with respect to FIGS. 1 to 4. In some embodiments, the plurality of tasks 544 may be similar to the tasks 144 described herein with respect to FIGS. 1 to 4. In some embodiments, the plurality of computing nodes 530 may be similar to the node computing devices 130 described herein with respect to FIGS. 1 to 4.

For each task of the plurality of tasks 544 of the task group 542, processing device 122 may access a version control system 520 to retrieve the task 544. Each task 544 may be stored as a data object within the version control system 520. In some embodiments, the version control system 540 may be similar to the version control computing device 120, including the version control engine 125 and/or version control store 140, as described herein with respect to FIGS. 1 to 4.

The respective tasks 544 of the plurality of tasks 544 may be transmitted to one or more of the plurality of computing nodes 530 for execution. In some embodiments, the respective tasks 544 may be transmitted over a network (such as network 102 of FIG. 1) between the computing device 510 and the plurality of computing nodes 530.

The device architecture 500 of FIG. 5 provides a technological capability to transparently track tasks 544 for execution within a task automation system 500. By using a version control system 520, tasks 544 may be re-used between task groups 542, and tasks 544 of a given task group 542 may be quickly modified, with the modifications automatically tracked. This allows a large number of task groups 542 to simultaneously exist in the version control system 520, while also allowing for the execution of the tasks 544 to be recorded as well. Embodiments of the present disclosure therefore provide an improvement to the computer technology associated with task automation, and improved the operation of the device architecture 500 by reducing the potential for errors in executing the tasks 544 and making the retrieval and storage of the task groups 542 (and their associated tasks 544) more efficient.

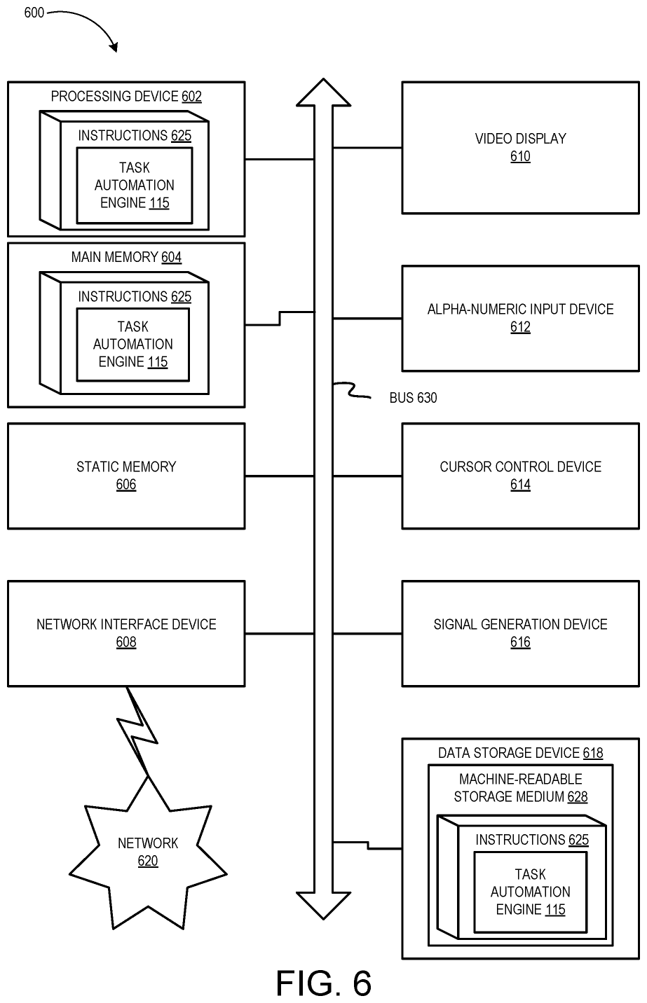

FIG. 6 is a block diagram of an example computing device 600 that may perform one or more of the operations described herein, in accordance with some embodiments of the disclosure. Computing device 600 may be connected to other computing devices in a LAN, an intranet, an extranet, and/or the Internet. The computing device may operate in the capacity of a server machine in client-server network environment or in the capacity of a client in a peer-to-peer network environment. The computing device may be provided by a personal computer (PC), a set-top box (STB), a server, a network router, switch or bridge, or any machine capable of executing a set of instructions (sequential or otherwise) that specify actions to be taken by that machine. Further, while only a single computing device is illustrated, the term “computing device” shall also be taken to include any collection of computing devices that individually or jointly execute a set (or multiple sets) of instructions to perform the methods discussed herein.

The example computing device 600 may include a processing device (e.g., a general purpose processor, a PLD, etc.) 602, a main memory 604 (e.g., synchronous dynamic random access memory (DRAM), read-only memory (ROM)), a static memory 606 (e.g., flash memory and a data storage device 618), which may communicate with each other via a bus 630.

Processing device 602 may be provided by one or more general-purpose processing devices such as a microprocessor, central processing unit, or the like. In an illustrative example, processing device 602 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. Processing device 602 may also include one or more special-purpose processing devices such as an application specific integrated circuit (ASIC), a field programmable gate array (FPGA), a digital signal processor (DSP), network processor, or the like. The processing device 602 may execute the operations described herein, in accordance with one or more aspects of the present disclosure, for performing the operations and steps discussed herein.

Computing device 600 may further include a network interface device 608 which may communicate with a network 620. The computing device 600 also may include a video display unit 610 (e.g., a liquid crystal display (LCD) or a cathode ray tube (CRT)), an alphanumeric input device 612 (e.g., a keyboard), a cursor control device 614 (e.g., a mouse) and an acoustic signal generation device 616 (e.g., a speaker). In one embodiment, video display unit 610, alphanumeric input device 612, and cursor control device 614 may be combined into a single component or device (e.g., an LCD touch screen).

Data storage device 618 may include a computer-readable storage medium 628 on which may be stored one or more sets of instructions 625 that may include instructions for a component (e.g., task automation engine 115 discussed herein) for carrying out the operations described herein, in accordance with one or more aspects of the present disclosure. Instructions 625 may also reside, completely or at least partially, within main memory 604 and/or within processing device 602 during execution thereof by computing device 600, main memory 604 and processing device 602 also constituting computer-readable media. The instructions 625 may further be transmitted or received over a network 620 via network interface device 608.

While computer-readable storage medium 628 is shown in an illustrative example to be a single medium, the term “computer-readable storage medium” should be taken to include a single medium or multiple media (e.g., a centralized or distributed database and/or associated caches and servers) that store the one or more sets of instructions. The term “computer-readable storage medium” shall also be taken to include any medium that is capable of storing, encoding, or carrying a set of instructions for execution by the machine and that cause the machine to perform the methods described herein. The term “computer-readable storage medium” shall accordingly be taken to include, but not be limited to, solid-state memories, optical media, and magnetic media.

Unless specifically stated otherwise, terms such as “obtaining,” “accessing,” “transmitting,” “modifying,” “merging,” “retrieving,” “replacing,” or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may comprise a general purpose computing device selectively programmed by a computer program stored in the computing device. Such a computer program may be stored in a computer-readable non-transitory storage medium.

The methods and illustrative examples described herein are not inherently related to any particular computer or other apparatus. Various general purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the term “engine” is not intended to be limiting of any particular implementation for accomplishing and/or performing the actions, operations, processes, etc., attributable to and/or performed by the engine. An engine may be, but is not limited to, software, hardware and/or firmware or any combination thereof that performs the specified functions including, but not limited to, any use of a general and/or specialized processing device in combination with appropriate software loaded or stored in a machine readable memory and executed by the processing device. Further, any name associated with a particular engine is, unless otherwise specified, for purposes of convenience of reference and not intended to be limiting to a specific implementation. Additionally, any functionality attributed to an engine may be equally performed by multiple engines, incorporated into and/or combined with the functionality of another engine of the same or different type, or distributed across one or more engines of various configurations.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting. As used herein, the term “and/or” includes any and all combination of one or more of the associated listed items.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. 112, sixth paragraph, for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the invention is not to be limited to the details given herein, but may be modified within the scope and equivalents of the appended claims.

What is claimed is:

1. A method comprising:
obtaining a configuration of a task group, the task group comprising a plurality of tasks, each of the plurality of tasks to execute on a computing node of a plurality of computing nodes;
for each task of the plurality of tasks of the task group, accessing, by a processing device, a version control system to retrieve the task, wherein each task is stored as a data object within the version control system; and
transmitting the respective tasks of the plurality of tasks to one or more of the plurality of computing nodes for execution.

2. The method of claim 1, wherein the task group is stored as a branch of a plurality of data objects of the version control system.

3. The method of claim 1, wherein the task group is a first task group, and wherein the method further comprises:
modifying a first task of the first task group to create a second task group by creating a branch from the first task group that includes a new data object comprising a second task.

4. The method of claim 3, further comprising:
merging the branch from the second task of the second task group to connect to a third task of the first task group.

5. The method of claim 2, wherein a first task of the plurality of tasks of the task group is included in at least one other task group.

6. The method of claim 1, wherein, for each task of the plurality of tasks of the task group, accessing the version control system to retrieve the task comprises sequentially retrieving each of the plurality of tasks from the version control system.

7. The method of claim 1, wherein at least one task of the plurality of tasks of the task group comprises an execution variable, and
wherein transmitting the respective tasks of the plurality of tasks to the one or more of the plurality of computing nodes for execution comprises replacing the execution variable with a data value associated with the task group during the execution of the at least one task.

8. A system comprising:
a memory; and
a processing device, operatively coupled to the memory, to:
obtain a configuration of a task group, the task group comprising a plurality of tasks, each of the plurality of tasks to execute on a computing node of a plurality of computing nodes;
for each task of the plurality of tasks of the task group, access a version control system to retrieve the task, wherein each task is stored as a data object within the version control system; and
transmit the respective tasks of the plurality of tasks to one or more of the plurality of computing nodes for execution.

9. The system of claim 8, wherein the task group is stored as a branch of a plurality of data objects of the version control system.

10. The system of claim 9, wherein the task group is a first task group, and
wherein the processing device is further to:
modify a first task of the first task group to create a second task group by creating a branch from the first task group that includes a new data object comprising a second task.

11. The system of claim 10, wherein the processing device is further to:
merge the branch from the second task of the second task group to connect to a third task of the first task group.

12. The system of claim 9, wherein a first task of the plurality of tasks of the task group is included in at least one other task group.

13. The system of claim 8, wherein, for each task of the plurality of tasks of the task group, to access the version control system to retrieve the task, the processing device is to sequentially retrieve each of the plurality of tasks from the version control system.

14. The system of claim 8, wherein at least one task of the plurality of tasks of the task group comprises an execution variable, and
wherein, to transmit the respective tasks of the plurality of tasks to the one or more of the plurality of computing nodes for execution, the processing device is to replace the execution variable with a data value associated with the task group during the execution of the at least one task.

15. A non-transitory computer-readable storage medium including instructions that, when executed by a processing device, cause the processing device to:
obtain a configuration of a task group, the task group comprising a plurality of tasks, each of the plurality of tasks to execute on a computing node of a plurality of computing nodes;
for each task of the plurality of tasks of the task group, access, by the processing device, a version control system to retrieve the task, wherein each task is stored as a data object within the version control system; and
transmit the respective tasks of the plurality of tasks to one or more of the plurality of computing nodes for execution.

16. The non-transitory computer-readable storage medium of claim 15, wherein the task group is stored as a branch of a plurality of data objects of the version control system,
wherein the task group is a first task group, and
wherein the processing device is further to:
modify a first task of the first task group to create a second task group by creating a branch from the first task group that includes a new data object comprising a second task.

17. The non-transitory computer-readable storage medium of claim 16, wherein the processing device is further to:
merge the branch from the second task of the second task group to connect to a third task of the first task group.

18. The non-transitory computer-readable storage medium of claim 16, wherein a first task of the plurality of tasks of the task group is included in at least one other task group.

19. The non-transitory computer-readable storage medium of claim 15, wherein, for each task of the plurality of tasks of the task group, to access the version control system to retrieve the task, the processing device is to sequentially retrieve each of the plurality of tasks from the version control system.

20. The non-transitory computer-readable storage medium of claim 15, wherein at least one task of the plurality of tasks of the task group comprises an execution variable, and
wherein, to transmit the respective tasks of the plurality of tasks to the one or more of the plurality of computing nodes for execution, the processing device is to replace the execution variable with a data value associated with the task group during the execution of the at least one task.
